(19) United States
(12) Patent Application Publication
(10) Pub. No.: US 2007/0067268 A1
(43) Pub. Date: Mar. 22, 2007

(54) Navigation of structured data

(75) Inventors: James Dai, Redmond, WA (US); Jamie Buckley, Redmond, WA (US); John Albert Solaro, Bellevue, WA (US); Laura Baldwin, Seattle, WA (US); Randall Friend Kern, Seattle, WA (US); Silviu-Petru Cucerzan, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 11/233,164

(22) Filed: Sep. 22, 2005

(51) Int. Cl. G06F 17/30

(52) U.S. Cl. 707/3

(57) ABSTRACT

A system and a method for facilitating navigation of stored information. A user interface configured to receive a search input is provided. In response to receipt of a search input, a data store is assessed. The data store may contain various information elements, and each of these elements may be tagged with one or more categorizing terms. Information elements are selected as potential answers to the search input, and the categorizing terms associated these potential answers are displayed in the user interface.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

In recent years, computer users have become more and more reliant upon computers to store and present a wide range of content including news, research, and entertainment. For example, the Internet, through its billions of Web pages, provides a vast and quickly growing library of information and resources.

In order to find desired content, computer users often make use of search utilities. For example, Internet search engines are well known in the art, and commonly known commercial engines include those provided by Google, Yahoo, and Microsoft Network (MSN™). In response to a user's search query, an Internet search engine will generally provide search results that list various Web pages that may contain desired content. Alternatively, search engines may use data other than Web pages to serve queries from end-users. For example, a search utility may traverse structured data including sports scores, movie show times, TV guide, weather and stock data. In some instances, structured data is utilized to give the answer to the user's query rather than a list of Web page links. For example, for the query “weather boston”, the current weather of Boston, Mass. is presented.

Despite the many capabilities of conventional search engines, deficiencies still exist in the art. For example, the underlying logic used by a conventional search engine in serving results is typically unavailable to the users. As a result, the user is not aware of how the search engine interprets queries, and the user is not capable of intelligently revising a query to more efficiently search the data. Further, search engines today do not provide insight into the structure of the available data, i.e., the categories of content being searched. Consequently, the user is not informed what data is available and, thus, cannot choose desired categories. Given these deficiencies, the user is often forced to attempt multiple search queries and/or to sift through irrelevant material before finding an acceptable answer. Accordingly, there is a need for improved techniques for providing search capabilities to a user.

### SUMMARY

The present invention meets the above needs and overcomes one or more deficiencies in the prior art by providing a system and method for facilitating navigation of stored information. In one embodiment, a user interface configured to receive a search input is provided. This interface may optionally be provided via the Internet. In response to receipt of a search input, a data store is accessed. The data store may contain various information elements, and each of these elements may be tagged with one or more terms categorizing the information element. These categorizing terms, for example, may describe various properties of the information element. Information elements are selected as potential answers to the search input, and the categorizing terms associated with these potential answers are displayed in the user interface. It should be noted that this Summary is provided to generally introduce the reader to one or more select concepts described below in the Detailed Description in a simplified form. This Summary is not intended to identify key and/or required features of the claimed subject matter, nor is it intended to be used as an aid in determining the scope of the claimed subject matter.

### BRIEF DESCRIPTION OF THE SEVERAL VIEWS OF THE DRAWINGS

The present invention is described in detail below with reference to the attached drawing figures, wherein:

FIG. 1 is a block diagram of a computing environment suitable for use in implementing the present invention;

FIG. 2 is a flow diagram showing a method for facilitating navigation of information stored in a data store in accordance with an embodiment of the present invention;

FIG. 3 is a block diagram of a system for generating answers responsive to a search input in accordance with an embodiment of the present invention;

FIG. 4 is an exemplary screen display of a graphical user interface in accordance with one embodiment of the present invention; and

FIG. 5 is a flow diagram showing a method for providing answer categories responsive to a user's query in accordance with an embodiment of the present invention.

### DETAILED DESCRIPTION

The subject matter of the present invention is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described. Further, the present invention is described in detail below with reference to the attached drawing figures, which are incorporated in their entirety by reference herein.

The present invention provides improved systems and methods for facilitating navigation of information stored in a data store. The invention may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present invention. The invention may be practiced in distributed-computing environments where tasks are performed by remote-processing devices that are linked through a communications network. In a distributed-computing environment, program modules may be located in both local and remote computer-storage media including memory storage devices. The computer-useable instructions form an interface to allow a computer to react according to a source of input. The instructions cooperate with other code segments to initiate a variety of tasks in response to data received in conjunction with the source of the received data.

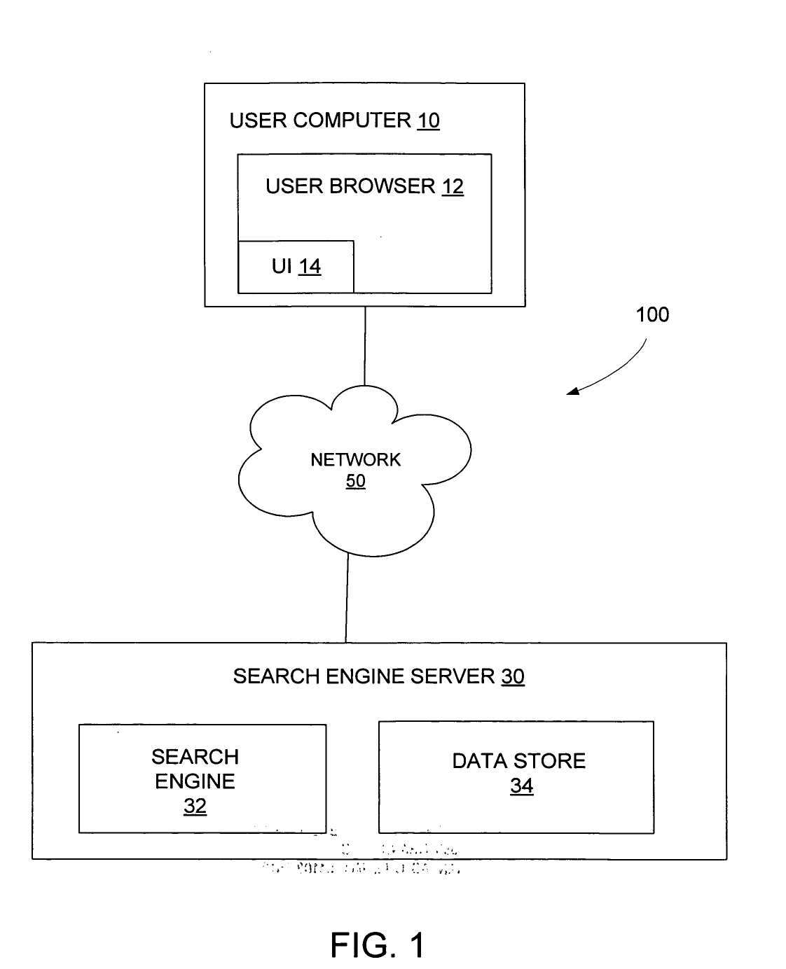

FIG. 1 illustrates a system 100 that represents an exemplary environment in which the present invention may be practiced. The system 100 including a user computer 10 having a user browser 12 accessible through a user interface (UI) 14. The user computer 10 may be connected over a network 50 to a search engine server 30. The search engine server 30 may include a search engine 32 and a data store 34. Other components that are not shown may also be included. In operation, the search engine 32 may traverse the data residing in the data store 34 to generate results in accordance with settings of the server 30. In operation, the user submits a query through the user browser 12 and receives results on the browser 12 as well.

The present invention may be implemented with a search engine capable of searching text and/or content. Those skilled in the art will recognize that the present invention may be implemented with any number of searching utilities. For example, an Internet search engine or a data store search engine may include the aspects of the present invention. These search engines are well known in the art, and commercially available engines share many similar processes.

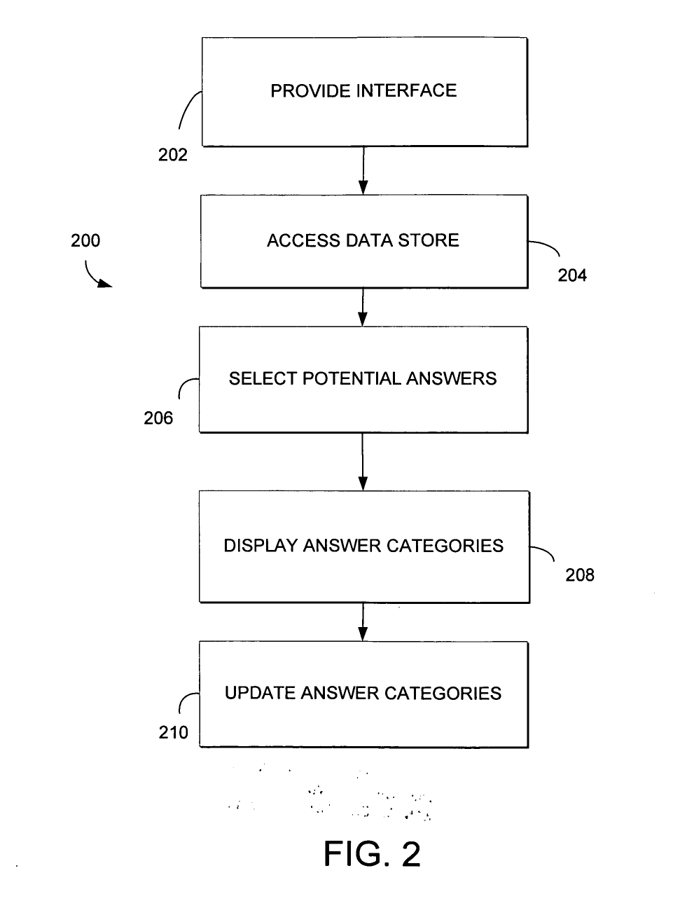

FIG. 2 provides a method 200 for facilitating navigation of information stored in a data store. At a step 200, the method 200 provides a user interface configured to receive a search input. Any number of user interfaces may be utilized by the present invention. For example, the user interface may be provided over a network such as the user interface 14 of FIG. 1. In this example, the user may use an Internet browser to display the interface and to input the search input.

The method 200, at a step 204, accesses a data store in response to receipt of a search input. The data store may contain a variety of structured (i.e. named) information elements. It should be noted that any type of content may be stored in the data store and that a variety of data stores or multiple data stores may be utilized by the present invention. In one embodiment, the data store receives the structured data from various knowledge-based entities. For example, the data store may receive real-time information such as sports scores, weather or news from these entities.

The data in the data store may be tagged with categorizing terms (or metadata) that describes the data by, for example, revealing various aspects of the data. In one embodiment, a portion of the categorizing terms may be inserted by the knowledge-based entities, while a portion may be inserted by the party in control of the data store. Any type of information may be stored as the categorizing terms. For example, a data element may have categorizing terms indicating that the underlying data relates to a restaurant in Houston, Tex. By utilizing this information, the element may be categorized as (1) a restaurant, (2) a location in Houston, and (3) a restaurant in Houston. The categorizing terms may take on any format or hierarchy. For example, the terms may include a set of key words describing the data. In this example, the ordering of the key words may be unimportant. Alternately, the categorizing terms may be arranged in accordance with a structure. As an example, categorizing terms associated with restaurants may dictate that the data be arranged as an array of strings indicating particular facts about the underlying data. This array may be [restaurant name; location; telephone number; type of food]. As will be subsequently discussed, the structure of the categorizing terms may be leveraged by search operations traversing the stored data.

At a step 206, the method 200 uses the categorizing terms to select information elements as potential answers to the search input. Those skilled in the art will appreciate that the method 200 may use any number of search utilities or heuristics to select information elements responsive to the search input. For example, using the search terms contained in the search input, the method 200 may seek each element having categorizing terms matching at least a portion of the search terms. As potential results are considered, the method 200 may use a relevancy ranking heuristic to determine which information elements should be selected. Such search techniques and relevant rankings are well known in the art, and the present invention is not limited to a particular search algorithm.

After the potential answers are selected, the method 200, at a step 208, displays a user interface containing a listing of the categorizing terms associated with the potential answers. This interface may be provided on a variety of devices such as a mobile handheld device and/or a mobile phone. As previously discussed, the categorizing terms are descriptive of the underlying data and, thus, provide insight into the various types of available data responsive to the search. For example, a search query may be “Michael Jordan”. Instead of returning web-pages about Michael Jordan, the method 200 will display categories of information such as statistics, biography, previous teams or video clips. Of course, each of these categories of information will have one or more associated information elements selected in response to the search query. The user interface may display only a sub-set of the categorizing information, and the information may be ranked in the interface by relevance.

At a step 210, the method 200 updates the listing of the categorizing terms in response to alteration of the search input. The alteration may be any change to the currently entered search input. The alteration, for example, may be the addition or removal of search terms. In one embodiment, the updating of the listing includes re-accessing the data store and re-selecting potential answers. Such updating may be done when any letter in the search input is changed or added. Returning to the “Michael Jordan” search query example, a user entering this query may be interested in Jordan's points-per-game average in the 1995-1996 season. When presented with the available information categories, the user may select to alter the query to “Michael Jordan statistics”. Response to this alteration, the method 200 may select each item of information in the data store having categorizing terms indicating that the underlying element relates to Jordan's statistics. From this listing, the user may select the category “Michael Jordan statistics points-per-game” and obtain the desired information. Thus, the interface allows the user to intelligently revise the search query and to zoom-in upon a desired piece of data. Similarly, the interface allows for efficient navigation of the available data by providing categorical listings responsive to a search query. Those skilled in the art will appreciate that this interface may provide a variety of information revealing the types of data available and relevant to a given search input.

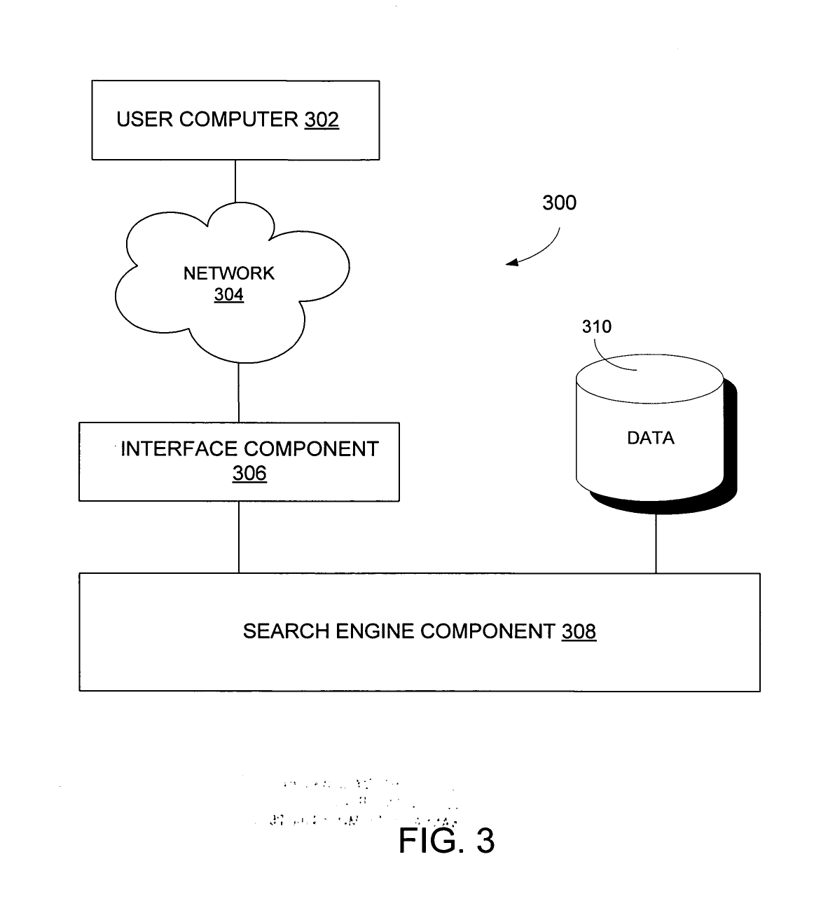

FIG. 3 illustrates a system 300 for generating answers responsive to a search input. The system 300 includes a data store 310 that contains information elements. Any type of information may be stored in the data store 310. This information may include web results, images, news and facts. The information may also include advertising content. For example, advertisers may pay for advertising content to be included in the data store 310 (and thus to be presented to users navigating amongst the stored information). In one embodiment, each information element is stored along with categorizing terms or metadata. These categorizing terms may be any information descriptive of the underlying information element, and the categorizing terms may indicate key aspects of the data to aid in navigation and querying operations. As previously discussed, the categorizing terms may be stored in accordance with any number of schemes.

A search engine component 308 is also included in the system 300. The search engine component 308 may be configured to access the data store and to select information elements as potential answers to a user's search input. In one embodiment, the search engine component 308 utilizes only the categorizing terms associated with the information elements to select the potential answers. For example, by comparing the search terms with the categorizing information, the search engine component 308 may identify which information elements are the most likely to answer the user's query. Those skilled in the art will recognize that various search utilities exist in the art and that the present invention may utilize any number of these known search techniques.

The system 300 also includes a user computer 302 which is connected to an interface component 306 via a network 304. The user computer may be the user computer 10 of FIG. 1, and the network 304 may be any network, such as the Internet. The interface component 306 may be configured to receive any number of user inputs including a search input. The search input may be entered as text, and/or the interface may provide user selectable options related to the desired content. For example, the search engine component 308 may provide an interface where the user can indicate whether the desired subject matter is a person, place or thing. As various search inputs are entered, the interface component 306 can communicate these inputs to the search engine component 308 for querying of the data store 310.

After the search engine component 308 selects potential answers to the search input, the interface component 306 may be configured to display a listing of the categorizing terms stored along with the potential answers. As the categorizing terms indicate the content of the underlying information, the user is able to see the types of information available in the data store 310. Further, the user can recognize the manner in which the search engine component 308 has interpreted the search input. If displeased with the presented categorizing terms, the user may revise the search input to alter the presented categories. Once the user recognizes a category matching a desired answer, the user may select to view the underlying information elements associated with this category. In one embodiment, the listing of the categorizing terms is automatically updated in response to alteration of the search input. In this embodiment, after any change or addition to the search input, the search engine component 308 re-queries the data store 310 and updates the selected potential answers. Then, the interface provided by the interface component 306 presents the categorizing terms associated with the selected potential answers. Those skilled in the art will recognize that, by automatically updating the listing of categorizing terms, the system 300 provides interactive feedback allowing the user to navigate amongst the available information elements.

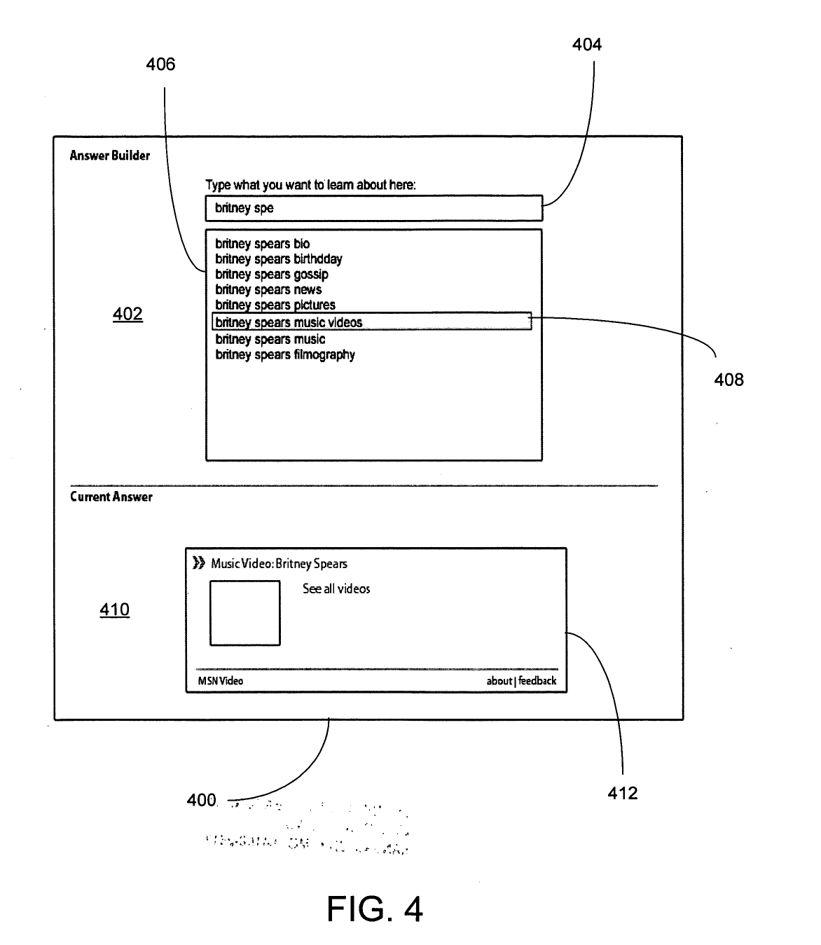

FIG. 4 provides an exemplary screen display of a graphical user interface 400 in accordance with one embodiment of the present invention. The interface 400 may be presented, for example, on a user's computer by an Internet browsing application. The interface 400 includes a first display area 402 having a search input area 404 and a category presentation area 406. The search input area 404 may accept a user input indicating the subject matter of desired content. For example, the search input area 404 is currently populated with the input “britney spe”. Responsive to the search input, the category presentation area 406 displays a listing of categories related to information that may be of interest to the user. This listing may be generated, for example, by a system such as the system 300 depicted by FIG. 3. Each of these categories relate to one or more elements of data selected as a potential answer to a user's query. For example, the most relevant information elements for the input “britney spe” may relate to the pop-singer Britney Spears. Thus, the category presentation area 406 may list the categorizing terms associated with each of these Britney Spears information elements.

Only a portion of the categorizing terms may be shown. For example, the categorizing terms may be stored in an hierarchical format in which each subsequent term provides a more precise characterization of the underlying data. Returning to the Britney Spears example, a user may desire to see a particular Britney Spears music video, and thus, may select the category “britney spears music videos” as indicated by a selection box 408. Responsive to this selection, a new listing of categories may be presented by providing the title of each of the Britney Spears music videos in the database. Thus, by iteratively presenting the various levels of categorizing information, the category presentation area 406 may allow the user to zoom-in on desired subject matter. Those skilled in the art will appreciate that this functionally will not only aid a user in finding an answer to a specific inquiry, but will also permit efficient navigation of related subject matter. For example, though the user desired to see only a specific music video, by presenting them with a listing of all of Britney Spears' music videos, they may also view the related video content.

The listing presented in the category presentation area 406 may be ranked for relevance, and additional information may be displayed with each of the listings. For example, an indication of the popularity or relevance of the category may be presented. The listing may inform the user of how likely a category may answer the user's query. By providing a confidence measure, the interface 400 may suggest the most-likely answers to the users. For example, for the query “weather boston”, the category presentation area 406 may indicate that the most-likely answer to the user's query is the current weather condition in Boston, Mass., while historical weather data may have low confidence indicators.

The interface 400 also includes a second display area 410 in which the current answer to a query is presented. The current answer may be the underlying information element(s) associated with a selected category listing. The selected category listing may be chosen by the user or may be selected automatically based on, for example, a relevancy ranking. Any aspect or preview of the underlying information elements may be presented in the second display area 410. For example, the selection box 408 indicates selection of the category “britney spears music videos”. Responsive to this selection, the screen area 412 presents information related to this category. For example, the screen area 412 may provide a listing of all Britney Spears' music videos in the data store. The screen area 412 may also display the underlying information elements associated with the selected category listing. Accordingly, the user may browse the underlying information to select items of interest.

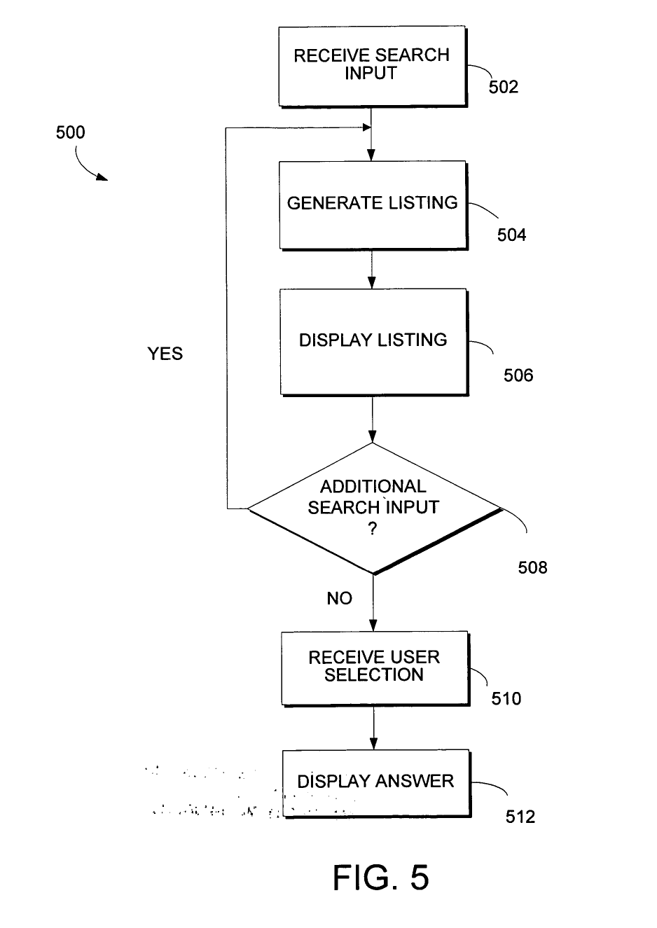

FIG. 5 illustrates a method 500 for providing answer categories responsive to a user's query. At a step 502, the method 500 receives a search input from a user. The input may be received via any number of user interfaces, and the search input may be any set of inputs indicating subject matter of interest to a user. It should be noted that even receipt of a single letter may be considered a search input in accordance with the present invention.

The method 500, at a step 504, generates a listing of answer categories in response to the search input, and, at a step 506, the method 500 displays this listing of answer categories to the user. Each of the answer categories correspond to one or more elements of information in a data store, and these elements of information are selected as potential answers to the search input. As previously set forth, a data store may store various elements of information along with characterizing terms indicating the content of the elements. In response to a search input, the method 500 may search the characterizing terms to select the elements of information that potentially answer the search input. In the end, the characterizing terms associated with these selected elements are used to generate the displayed answer categories.

At a step 508, the method 500 determines whether additional search inputs have been received. Additional search inputs may be any change to the input or may be any additional search terms. In one embodiment, the addition, removal or alteration of a single character in the search input will be deemed an additional search input.

When an additional search input is received, the method 500 repeats the steps 504 and 506. Accordingly, after each change to the search input, a revised listing of answer categories is presented to the user. As will be appreciated by those skilled in the art, by updating the listed answer categories after each additional search input, the user is provided real-time feedback allowing for intelligent revisions to the search input and for efficient navigation of the available information elements.

Once no more additional search inputs are received, the method 500 receives a user selection of one of the listed categories at a step 510. Responsive to this input, the method 500 may display the underlying information associated with the listed categories. When more than one element of information is associated with the selected category, the user may be presented with additional information about the elements. In one embodiment, after selection of a category, the user is presented a listing of sub-categories of the selected category. The user is thus able to zoom-in on a desired answer.

At a step 512, the method 500 displays a selected element of information to the user. Any presentation of the information may be appropriate. Those skilled in the art will appreciate that, as the user arrives at this answer through an iterative process of refining the search input and by selecting categories of interest, the answer presented at the step 512 may provide information of significance to the user.

Alternative embodiments and implementations of the present invention will become apparent to those skilled in the art to which it pertains upon review of the specification, including the drawing figures. Accordingly, the scope of the present invention is defined by the appended claims rather than the foregoing description.

The invention claimed is:

1. A method for facilitating navigation of stored information, said method comprising:
providing a user interface configured to receive a search input;
in response to receipt of said search input, accessing a data store containing a plurality of information elements, wherein each of said plurality of information elements is associated with one or more categorizing terms;
selecting one or more of said plurality of information elements as potential answers to said search input; and
displaying in said user interface at least one of the one or more categorizing terms associated with each of at least a portion of said potential answers.

2. The method of claim 1, wherein said potential answers are selected by comparing said search input with at least a portion of the one or more categorizing terms associated with each of at least a portion of the plurality of information elements.

3. The method of claim 1, wherein said user interface is provided on at least one of a mobile handheld device and a mobile telephone.

4. The method of claim 1, wherein each of said plurality of information elements is associated at least one categorizing term that describes one or more property of the information element.

5. The method of claim 1, further comprising re-selecting potential answers in response to alteration of said search input.

6. The method of claim 5, further comprising updating the display of said one of the one or more categorizing terms in response to said re-selecting.

7. The method of claim 1, wherein at least a portion of said one or more categorizing terms are organized in accordance with a hierarchical schema.

8. One or more computer-readable media having computer-useable instructions embodied thereon to perform the method of claim 1.

9. A system for generating answers responsive to a search input, said system comprising:
a data store containing a plurality of information elements, wherein each of said plurality of information elements is stored along with one or more categorizing terms;
a search component configured to access said data store and to select one or more of said plurality of information elements as potential answers to said search input, wherein said potential answers are updated in response to alteration of said search input; and
a user interface component configured to receive said search input and to present at least a portion of said potential answers to the user by displaying at least one of said one or more categorizing terms for each of said portion of said potential answers.

10. The system of claim 9, wherein said search component is configured to select said potential answers by consideration of at least a portion of the one or more categorizing terms associated with each of said plurality of information elements.

11. The system of claim 9, wherein said user interface component is configured to provide a user interface on remote locations in a network.

12. The system of claim 10, wherein said user interface is accessible over the Internet.

13. The system of claim 9, wherein said user interface component is configured to present advertising content in response to a user input selecting one of said potential answers.

14. A computer-implemented method for providing answer categories responsive to a user's query, said method comprising:
(a) receiving a search input from a user;
(b) generating a listing of one or more answer categories in response to said search input, wherein each of said one or more answer categories corresponds to one or more elements of information in a data store selected as potential answers to said search input;
(c) displaying at least a portion of said listing to the user; and
(d) repeating said step (b) and said step (c) in response to receipt of additions to said search input or in response to alteration of said search input.

15. The method of claim 14, wherein each of said one or more elements of information is stored along with one or more categorizing terms that describe one or more property of the information element.

16. The method of claim 15, wherein each of said one or more answer categories is described in said listing with at least a portion of the one or more categorizing terms corresponding to at least a portion of said potential answers.

17. The method of claim 14, wherein said generating the listing includes grouping together one or more of said potential answers.

18. The method of claim 14, further comprising displaying a confidence measure for each of at least a portion of said one or more answer categories, wherein said confidence measure indicates a probability that the answer category answers the user's query.

19. The method of claim 14, further comprising providing an Internet-based user interface for receiving said search input and for displaying said listing.

20. One or more computer-readable media having computer-useable instructions embodied thereon to perform the method of claim 14.
